(19) United States
(12) Patent Application Publication
(10) Pub. No.: US 2013/0232435 A1
(43) Pub. Date: Sep. 5, 2013

(54) MAP BASED EVENT NAVIGATION AND VENUE RECOMMENDATION SYSTEM

(71) Applicant: MYSPACE LLC, Beverly Hills, CA (US)

(72) Inventor: Jason J. A. Knapp, Solana Beach, CA (US)

(73) Assignee: MYSPACE LLC, Beverly Hills, CA (US)

(21) Appl. No.: 13/786,224

(22) Filed: Mar. 5, 2013

Related U.S. Application Data
(60) Provisional application No. 61/606,878, filed on Mar. 5, 2012.

(51) Int. Cl. G06F 3/0484

(52) U.S. Cl. CPC G06F 3/0484
USPC 715/771

(57) ABSTRACT

A method and system provide the ability to deliver event-based information and providing an event venue recommendation. An event site is established that corresponds to an event that multiple persons attend and is an electronic repository for content related to the event. Content is received from an attendee of the event and is used to populate the event site. A graphical user interface of a map may be populated with a representation of the event and provides navigation capabilities for a user to locate different events on the map. An event is selected in the map and based thereon, content from the event is delivered to a user. The content may also be analyzed to extrapolate information about the attendee. Based on the extrapolated information, a candidate event location may be determined and transmitted as an event venue recommendation.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Patent Application Ser. No. 61/606,878, entitled “MAP BASED EVENT NAVIGATION AND VENUE RECOMMENDATION SYSTEM”, by Jason J. A. Knapp, filed on Mar. 5, 2012, Attorney Docket No. 257.7-US-P1.

This application is related to the following co-pending and commonly-assigned patent application, which application is incorporated by reference herein:

U.S. patent application Ser. No. ______, entitled “EVENT APPLICATION”, by Jason J. A. Knapp, et. al., filed on the same date herewith, Attorney Docket No. 257.6-US-U1 which application claims priority to U.S. Patent Application Ser. No. 61/606,858, entitled “EVENT APPLICATION”, by Jason J. A. Knapp, et. al., filed on Mar. 5, 2012, Attorney Docket No. 257.6-US-P1.

### BACKGROUND OF THE INVENTION

1. Field of the Invention

The present invention relates generally to social media content, and in particular, to a method, apparatus, and article of manufacture for navigating a geographic map to find an event as well as recommending a venue/location to an attendee and/or a performer/participant.

2. Description of the Related Art

Many fans of artists, sports, etc. frequently attend events featuring particular artists, teams, etc. Prior to attending an event, a fan may look at reviews and other information to determine how a particular artist performs or whether a particular venue/game/artist is exciting to watch in person. In addition, some sports/music fans may not be able to attend a particular event and/or are curious what is currently happening at such an event. To view such information in the prior art, a user may need to watch the live broadcast on television, read news articles describing the event, or contact a friend that is actually attending the event. However, such information may not satisfy an avid fan's insatiable desire for a particular event.

In addition to the above, performers, artists, politicians, and other similar event participants (including promoters of such events) may frequently attempt to determine the optimal venue and/or location to host an event for he/she/them to feature in. Prior art systems fail to provide a mechanism that determines, evaluates, and provides an accurate recommendation for a venue and performance data that will maximize attendance and thereby optimize revenue for the event participant/promoter.

In view of the above, what is needed is the capability to easily find an event and view information about such an event in an efficient manner. What is further needed is the capability to evaluate and suggest a venue and location for a performer/participant to host an event based on concrete user data and preferences.

### SUMMARY OF THE INVENTION

Embodiments of the invention provide an interactive web presence for an event that provides the ability for users to upload content directly from the actual event using a mobile application. In addition, users (that are attending or are not attending the event) are provided with a map based navigation system that is integrated with the event web presence. After finding an event of interest, the user can view content for the event in a unique manner that may be timeline based.

Embodiments of the invention further provide a venue/location recommendation based on a fan base in a particular region that is determined from the event web presence.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the general structure and interaction within an event based framework/system in accordance with one or more embodiments of the invention;

FIG. 4 illustrates an example of a user interface that may be used to filter events/event sites in accordance with one or more embodiments of the invention;

FIG. 5 illustrates the logical flow for providing map based event navigation in accordance with one or more embodiments of the invention; and

FIG. 6 illustrates the logical flow for providing a concert venue recommendation in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

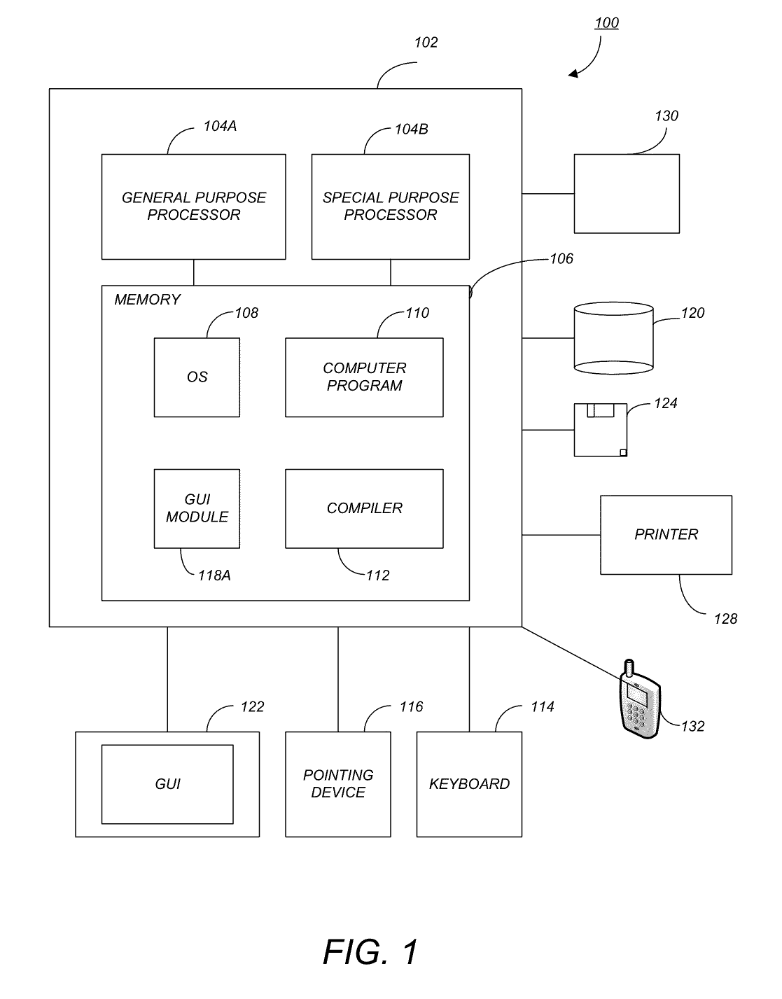

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may comprise or may be coupled to and/or integrated with other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to or may comprise a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

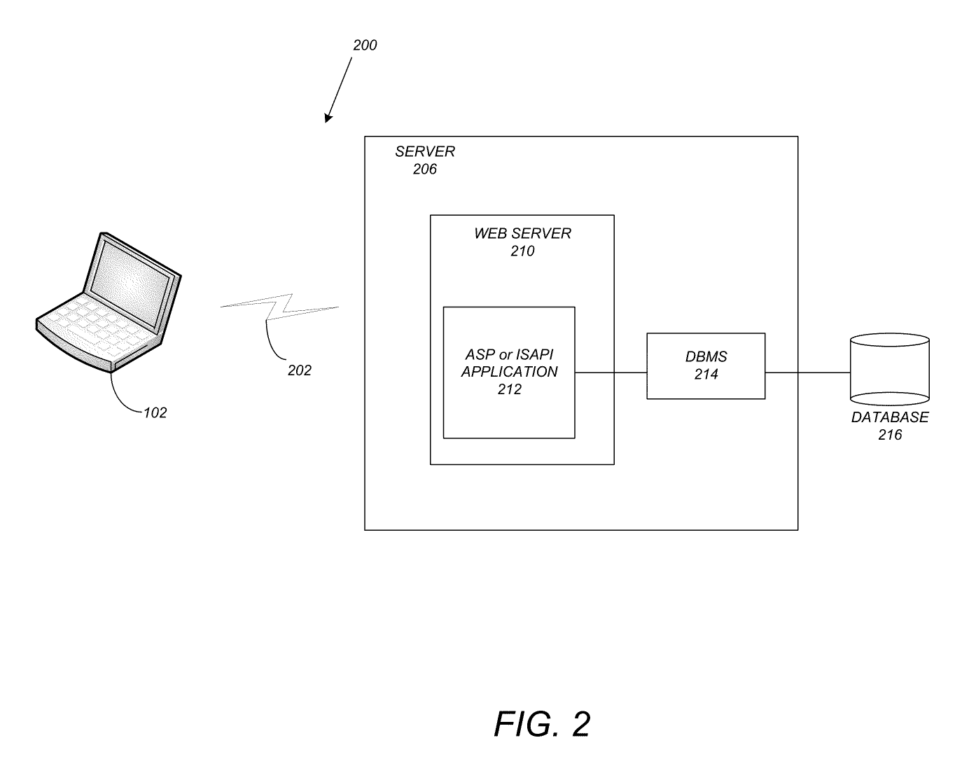

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 in accordance with embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROMET™, etc. Further, the software executing on clients 102 may be downloaded from server computer 206 to client computers 102 and installed as a plug in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of or connected directly to client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include thin client devices with limited or full processing capabilities, portable devices such as cell phones, notebook computers, pocket computers, multi-touch devices, and/or any other device with suitable processing, communication, and input/output capability.

Of course, those skilled in the art will recognize that any combination of the above components, or any number of different components, peripherals, and other devices, may be used with computers 102 and 206.

### Event Site Overview

Embodiments of the invention are implemented as a software application executing on a client 102, server computer 206, or a combination of both client 102 and server 206. Further, as described above, the client 102 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 102, portable device, etc.

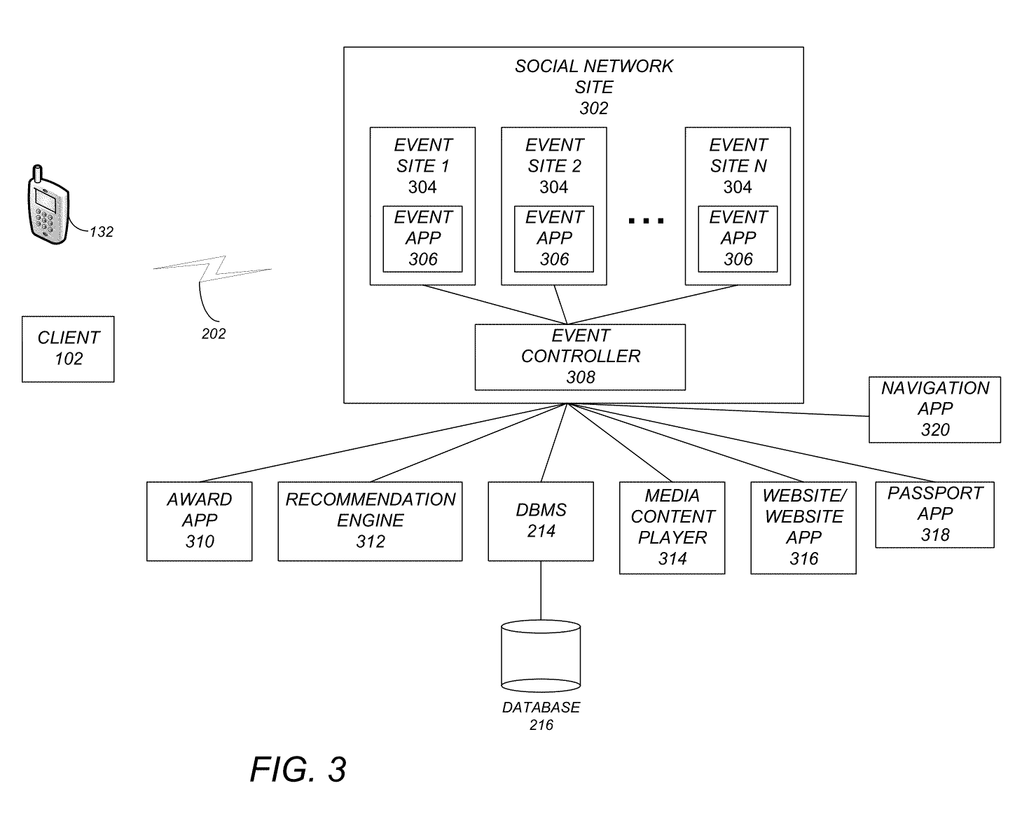

FIG. 3 illustrates the general structure and interaction within an event based framework/system in accordance with one or more embodiments of the invention. As described above, mobile device 132 and/or client 102 may communicate and interact using a variety of networks 202 with various websites and applications. Mobile application software (commonly referred to as an “app”) may be installed and/or utilized on mobile devices 102 and/or clients 102. Such an app may be downloaded from an application marketplace or online store of applications. The app may be used to provide the functionality herein. In addition, various apps may be used in combination with server side applications to provide the desired functionality. In this regard, in addition to, or instead of, an event app on a mobile/client device 102/132, an application for the user to check-in or submit his/her location may be used (e.g., FourSquare™).

On the server side 206, a social network site 302 (e.g., MySpace™ Facebook™, LinkedIn™, Friendster™, Twitter™), may be used to host various event sites 304 (e.g., event site 1, event site 2, . . . , event site N). Such event sites are described in further detail below and correspond to actual events that occurring at a particular venue. Each event site 304 may utilize an event application 306 to manage the information for the event site 304. Further, an event controller 308 may be used to combine, manage, and provide access to information from multiple event sites 304/event applications 306.

Either as part of the social network site 302 or executing separately from the social network site 302, various applications 310-320 may be used to provide additional features for the event based interaction. The use of such applications 310-320 are described in further detail below (or in the cross referenced application). It may be noted that the description is not limited to the applications depicted in FIG. 3 and additional applications may be used to provide the features described herein. Further, in addition to the applications 310-330 interacting with (or being an integral part of) social network site 302, each application 302-320 may interact with the other applications 302-320 and or directly with the user 102/132.

To better understand the event based framework and system, an overview of each of the depicted applications' tasks within the event based framework may be useful. Award application 310 manages awards, award programs, and achievements based on a user's 102/132 level/state of participation and interaction with the event based system. Recommendation engine 312 is used to recommend content, events, etc. to a user 102/132 based on event based content. In addition, recommendation engine 312 may be utilized to recommend a particular location/venue to host an event. DBMS 214 manages all of the event based data that may be stored in database 216. Media content player 314 enables the ability to view media content uploaded by users 102/132. Websites/website apps 316 are websites other than the social network site 302 (e.g., Twitter™, search engines, map-based interactions, etc.) that may use the event based information or provide additional information based on the event based information. Such websites/website apps 316 also interact with the event app 306 and/or event controller 308. Passport app 320 enables the use of an event passport/passport book that serves as a listing or registry of which events one or more users 102/132 have attended. Navigation application 320 provides the ability to utilize a graphical user interface to navigate and find a particular event and then view content for such an event in unique manner.

As described herein, an event (e.g., a concert, a sporting event, a party, a charity event, a theatrical production, or any event that may be attended/watched by a user) may have a corresponding event internet presence (referred to herein as an event site or event location 304) that is hosted by a server computer 206. Such an event site 304 may be an application 212 hosted by web server 210, and/or may be a page on a social media network 302 such as a MySpace™ page, a Facebook™ page, a Google+™ page, a LinkedIn™ page, etc.

The event site 304 may utilize an event application 306 to organize and store the information on a per event site 304 basis. In general, the event site 304 (and supporting applications 306-320) provides the ability for users 102/132 to “check into” an event and upload content directly from the actual event using a mobile application. The server 206 (e.g., via the event app 306, event controller 308, and or other applications) may verify the user's location at the event (e.g., via global positioning system [GPS] information encoded in a picture or transmitted from the mobile device) (and may also confirm the content location) and tags the data appropriately. The event site 304 serves as an aggregate for the user content uploaded from the event. Any user 102/132 can visit the site and view the content. Alternatively, access permissions may be restricted (e.g., private event functions [e.g., birthday parties, exclusive parties at private estates, etc.] may have access restricted to only those persons that attended/were invited to the event).

The uploaded content may be pictures, sound, video, information about the event or participants in the event, and information about the pictures, sound, video, or other content (e.g., attributes about the content), etc. The content described herein is not intended to be limited to specific content or types of content. For example, at a baseball game, content may include a picture of a message displayed on a big screen, a picture of any of the players (in the dugout or otherwise), who is at bat, what celebrities are attending the game, the total attendance, where a beach ball is currently being hit, where a “wave” is starting, how long the lines are at the different concessions or in the bathrooms, where to buy certain types of food, GPS data associated with any of the above, etc. Similarly, at a concert, content may include the current song being played, a picture of the band, a picture of an attendee, a picture of a ticket to the concert, what clothing a particular artist is wearing, etc.

The event site 304 may enable usage of the event site 304 before, during, and subsequent to the occurrence of the event. Before the event occurs, users 102/132 can view the scheduled participants (e.g., the scheduled pitchers or players at a baseball game, scheduled artists at a concert, etc.) and/or information about the event (e.g., songs played at other similar concerts, the scheduled playlist, information about the instruments being played and similar artists that play the same/similar instruments, information about the promoter, the master of ceremonies (MC), production crew, etc.). Users 102/132 may also have the potential to purchase tickets to the event or link to another site 316 to purchase tickets.

During the event itself, content is uploaded and may be streamed and/or used by users 102/132 (e.g., in real-time). Such content may be used to find concessions/bathrooms (e.g., with the shortest line), meet up with friends, view what is happening at a different location at the venue, etc.). Users 102/132 not at the event may also have the ability to view uploaded content to attend the event “virtually”.

After the event, users 102/132 can view and interact with the uploaded content (e.g., including the set played by an artist, pictures, video, etc.). Similarly, content uploaded may be utilized by other applications 310-318. As an example, a music player 314 may utilize the content such that when playing a song, relevant content (e.g., pictures of the artist playing that song at a particular concert) may be displayed to the user 102/132. Alternatively, a user 102/132 can “relive” the event wherein the content (and accompanying information) is organized in a timeline like manner and delivered to the user 102/132 such that the user 102/132 can replay the content in an attempt to experience/re-experience the evening. For example, a user 102/132 can attempt to replay a concert event. In such a scenario, the application 306 may replay/stream music to the user 102/132 in the order that the band played the set at the concert event. Simultaneously, the application 306 may display pictures, audio, video, etc. that is synchronized with the music (e.g., the time when the content was captured by a user 102/132 may be synchronized with when a particular song was played by a band and delivered to the user 102/132 in a time appropriate manner).

Accordingly, the application controller 308 (e.g., via the event app 306) may offer various options to one or more users 102/132 regarding how the content can be delivered to the user 102/132. The user 102/132 may also opt to simply browse all uploaded content. In yet another embodiment, a user 102/132 can elect to filter the content based on a variety of factors/attributes. Some filtering options may include filtering the content by: the user 102/132 that uploaded the content, the type of device that captured the content (e.g., cellular phone v. digital camera v. tablet/multi-touch device), the location at the actual event where the content was captured (e.g., filtering content such that only content captured by users 102/132 in the first ten rows or in a particular venue section will be viewed by the user 102/132), by properties of the user 102/132 that captured the content (e.g., gender, age, profile of user 102/132 compared to the present user 102/132, etc.), by age appropriateness (e.g., if the content is marked with containing risque content, it may be filtered out, or content may be filtered based on being appropriate for all ages, only over 13, only over 18, etc.), by what is depicted in the content (e.g., filtering out all content but for images of the band members or certain band members—i.e., such that candid photos of other attendees at the event are excluded—or vice versa), etc. In this regard, any type of filtering system may be in place and a variety of different properties and attributes may be used to filter the content.

To further provide the ability to organize and filter the content in a desirable manner, the uploaded content may be tagged. Such tagging associates the content with a variety of attributes. In this regard, content may be associated with a song, event, playlist, users 102/132 (having a particular songs on a playlist, that have attended a particular concert, that uploaded a song at a concert, etc.), musical type/genre, venue, time captured, what/who is depicted in the picture, location (e.g., general seating section, exact seat location, and/or GPS location), etc.

Such content may be tagged by the user 102/132. Alternatively, the content may be tagged automatically by the application 306 (or other applications 310-320 that are configured to discover the tags) based on various properties. For example, based on GPS data that accompanies a photograph, the application 306-320 may search for and/or compare the GPS data to known GPS data for a particular venue and may further determine where the content was captured within the venue (e.g., what seating area or the exact location). The timestamp associated with the content may then be used to determine what event occurred, what was occurring at that time in the event (i.e., based on other user 102/132 uploaded content), etc. All such information may be associated with the content (e.g., via tags).

Automatic or manual tagging may also be initiated based on an ongoing activity at the event. For example, a user 102/132 may check-in at an event. The application 306-320 (or a mobile application on the mobile device 132 itself) may then perform an analysis of the audio content received (e.g., streamed to the application) to determine/identify what the content is (e.g., audio recognition of a particular song at a concert). Such an identification of the content may also utilize the “check-in” information to assist in the discovery process (e.g., by filtering songs from an artist performing at the venue). The application 306 may then request confirmation of the determination/identification and then store such content at the event site 304 (e.g., in database 216 via DBMS 214). In this regard, the time when a particular song is played may be automatically determined and stored at the event site 304 by an event application 306. Alternatively, rather than identifying/recognizing content based on audio, a user 102/132 may opt to submit identifying information based on text entries (e.g., via a mobile device 132 keyboard/text message). For example, at a concert, the user 102/132 may enter the first letter (or first few letters) of a song at a particular concert and the event app (e.g., on the mobile device 132) may match the letters with a listing of songs by the artist and thereby recognize the song, or alternatively, present a list of songs for the user 102/132 to select from (i.e., based on the letters entered by the user 102/132).

A tagging infrastructure may also be utilized. Such a tagging infrastructure serves to establish a relationships for (and between) the uploaded content. For example, certain songs may be associated with a particular concert, events may be associated with artists/athletes, music at a concert may be associated with users 102/132 that have such music on their own playlists, etc. Such relationships between data may be stored in a database 216 and managed by a relational DBMS 214.

### Map-Based Event Navigation

In one or more embodiments of the invention, map based navigation options may be integrated with the event site 304 information (e.g., via navigation application 320). In this regard, users 102/132 may have the ability to view a geographic map and see what concerts are currently occurring, recently occurred in the past, or are going to occur at or within a designated time in the future. Alternatively, a text based search for an event may also be utilized.

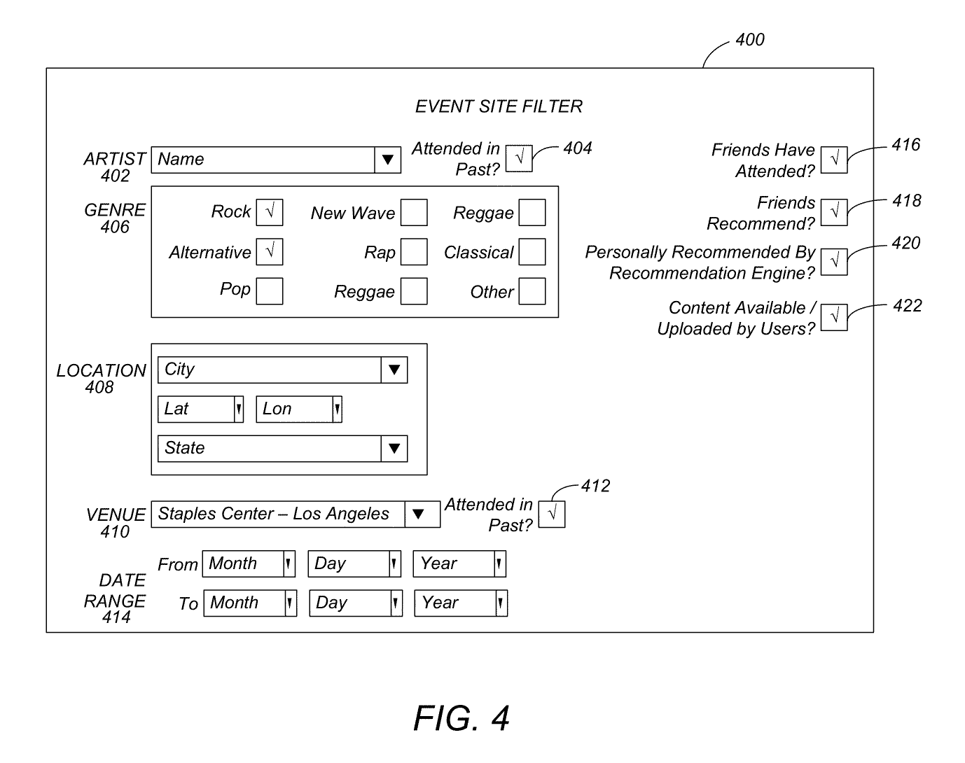

Various filters may be used to narrow the navigation options to a particular genre, venue, artist, date/date range, etc. FIG. 4 illustrates an example of a user interface that may be used to filter events/event sites 304 in accordance with one or more embodiments of the invention. Note that the filters that may be used are not limited to those provided in graphical user interface 400. Various user interface controls may be used such as check boxes, combo boxes, command buttons, frames, images, labels, list boxes, radio buttons, text boxes, scroll bars, spin buttons, tab strips, toggle buttons, etc.

As illustrated, a user 102/132 may have the option to identify the artist/performer 402 and whether the user 102/132 has attended an event featuring the performer in the past 404. The event sites 304 may further be filtered by the genre 406, location 408, venue 410 (and whether the user 102/132 has attended the venue in the past 412), and date range 414. In addition, various other filtering attributes 416-422 may be utilized that are unique to the social media network and/or embodiments of the present invention. In other words, the filtering attributes 416-422 are attributes that are based on information that is uniquely maintained by (i.e., are unique to) a social media network. For example, the results may be filtered by whether a friend has attended 416 the event and/or similar events in the past. Similarly, event sites 304 may be filtered based on whether friends recommend 418 the event or the event site. The user 102/132 may further elect to limit results based on whether the event site has been personally recommended 420 to the user 102/132 by a recommendation engine 312. In other words, based on the user's profile and other known information, a recommendation engine 312 may recommend a particular event site/event and the user 102/132 can opt to limit/filter the results of the search to recommended sites. The user 102/132 may also filter event sites based on whether media content is available for viewing at the event site 422. In other words, if no users 102/132 have uploaded content, the user 102/132 may not want to see/view such an event site.

The results of such a search/filter may be displayed in a geographic map with glyphs/icons indicating the location of the various events identified. Colors/geometry of the icons/glyphs may be used to distinguish various features of the event site (e.g., a past event in a first color, a currently ongoing event in a second color, and a future event in a third color) (e.g., different highlighting based on whether content is available). Hovering over a particular icon/glyph may display a tooltip with information regarding the event/event site. The map user interface may be navigated using various types of navigation controls commonly available such as zooming, translating, etc.

Once an event site of interest has been identified and selected by the user 102/132 (e.g., by selecting an icon/glyph using a cursor control device), the event site 304 itself may be displayed to the user 102/132. Once the event site 304 is displayed, various features of the event site 304 may be available to the user 102/132. For example, the user 102/132 may view media content (e.g., all or a portion) uploaded by users 102/132 of the event site 304. Such media content may be displayed on a timeline like manner based on the time of upload or the time of capture (e.g., of a time-stamped picture). The user 102/132 may have the option of rewinding or fast forwarding through the media content/event-based information on the event site 304. In this regard, the content may be delivered/broadcast in a stream that is stored on the server and delivered to the user 102/132 in the format requested. Alternatively, if an entire stream is received by the user 102/132, the user's system may cache the stream and the event app on the client may provide the functionality to fast forward or rewind.

The event-based information/content may be viewed in a timeline like window/media player that is configured to display the content to the user 102/132.

In view of the above, various methods and/or protocols may be used to deliver the event content from the event site 304 to the user 102/132. For example, the content may use datagram protocols, real-time streaming/transport/transport control protocols, bitrate streaming, transmission control protocol (TCP), unicast protocols, multicast protocols, IP (internet protocol) multicast, and/or peer-to-peer protocols.

Accordingly, the user 102/132 has the ability to select an ongoing event such as a concert and “tune-in” to the concert. Embodiments of the invention may further broadcast live audio feed from the event. Alternatively, if the live audio feed is not possible, based on uploaded information (e.g., the particular song being played by an artist), the event site 304 may play a pre-recorded version of media content (e.g., a particular song/track from the artist's record) while displaying/providing images from the event to the user 102/132. Such a play of the artist's content may be synchronized (as best as possible) with the song being played at the concert. Thus, simultaneously with the pre-recorded track, media content uploaded in real-time may be played to the user 102/132 thereby providing the user 102/132 with a desktop/mobile virtual concert/event.

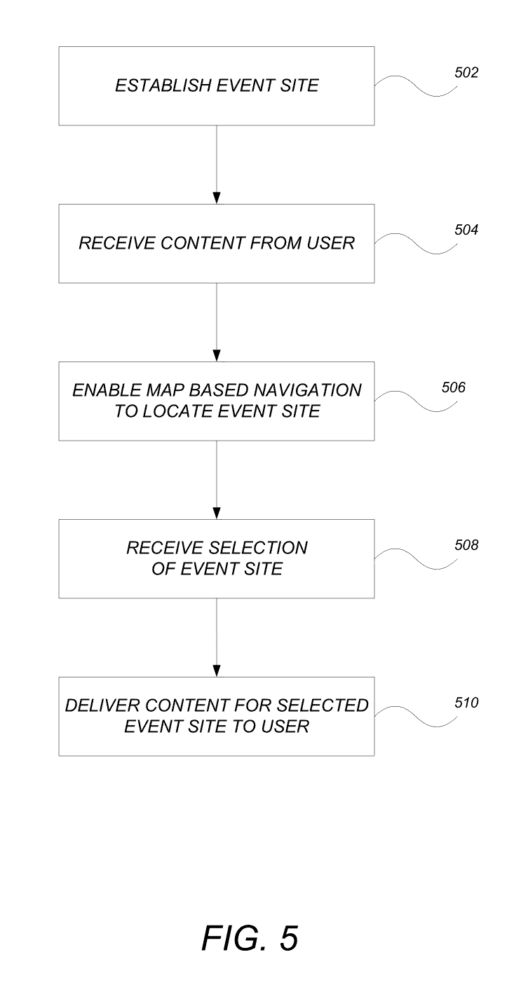

FIG. 5 illustrates the logical flow for providing map based event navigation in accordance with one or more embodiments of the invention.

At step 502, one or more event sites are established.

At step 504, content from users are received and used to populate the event sites.

At step 506, map based navigation to locate an event site is enabled. Such an enabling may include populating location based information for events represented by each of the created event sites and utilizing such location based information to populate a graphical user interface of a map that allows users 102/132 to navigate and find the different events.

At step 508, the map based navigation receives a selection of a particular event site. For example, the selection may activate a hyperlink or uniform resource locator (URL) that transports the user 102/132 (e.g., via a web browser) to the event site itself.

At step 510, the event site is used to deliver content to the user 102/132. As described above, such content may be streamed via multicast or unicast, and may provide the ability to fast forward and/or rewind the content which may be organized by time/date of upload or time/date of content capture.

### Concert Venue Recommendation

Embodiments of the invention may enable the ability to develop/supplement a profile for a user 102/132 that interacts with the event site 304 described above. Further, each event site 304 may maintain statistics/information regarding the users 102/132/types of users 102/132 (e.g., residence location, gender, music preferences, venue preferences, event preferences, etc.). Such statistics may be maintained for users 102/132 that have attended the event and/or users 102/132 that have uploaded content to the event site 304. For example, statistics regarding the residences (e.g., cities, state, location within a city, etc.) of the users 102/132 that attend(ed) a particular event may be maintained.

A statistical analysis of such information may be used to manipulate the information and update a user's profile. The profile information may also be developed/modified based on a user's interaction with a social network site (e.g., MySpace™). The profile based information may be based on the statistical analysis/manipulation of the user's information. For example, if a user 102/132 has attended multiple similar events (e.g., multiple concerts for a particular artist or multiple concerts in a particular genre of music), the user's profile may be modified to reflect that the user 102/132 is a “fan” of such events, artists, performers, venue, etc. As used herein, the user's profile may be the public or may be information (e.g., metadata) maintained internally about a user 102/132.

Based on user based profile information and/or event-based information, embodiments of the invention (e.g., the recommendation engine 312 or the event controller 308) may utilize logic to develop a profile (e.g., a demographic profile) for a particular location (e.g., city or part of a city, state, region, etc.), venue, artist, sport, etc. In this regard, the recommendation engine 312 (e.g., via DBMS 214 and database 216) may modify the profile for a particular area(s) of Los Angeles (e.g., Santa Monica and/or Venice Beach) indicating that such an area has a large fan base of persons that like alternative rock (or a specific band). Statistical analysis and logic may also be utilized to determine the likelihood of such users 102/132 willingness to attend an event for a particular artist/genre within a certain city or at a certain venue. In this regard, a user's profile may include information regarding attendance at various events, location of such attendance, preference for certain artists and/or genres of music, etc. Such information may be utilized to predict the likelihood of attendance at a particular event. Such predictions and statistics may be accumulated across numerous users 102/132.

Based on the accumulation of data across a group of users 102/132, the recommendation engine 312 may provide a recommendation to an artist, team, production company, etc. regarding the optimal location to host an event. As an example, suppose the statistics indicate that 2000 people in the Lake Charles, La. vicinity are fans of Derek Trucks and are likely to attend a local concert featuring Derek Trucks. Based on such statistics, recommendation engine 312 may recommend to Derek Trucks, his band, or his manager, that he should host a concert at a facility in the Lake Charles area that accommodates 2000 people or less (e.g., the L'auberge Casino Resort™). Similar recommendations may be made regarding the ticket prices (e.g., based on the income of the users 102/132 and/or cost of prior tickets paid by the users 102/132 at the venue).

Such recommendations may also include a recommended season/date/time for hosting the event. For example, if trends/statistical analysis indicate that attendance is likely higher during the Spring/spring break at a particular location (e.g., Fort Lauderdale or Cancun), such a time may be recommended to a potential event host.

Similarly, recommendation engine 312 may provide recommendations to users 102/132 regarding when and where a particular artist is playing at a user's preferred venue, a nearby venue, or when similar artists (e.g., in the same genre as an artist the user is a “fan” of) are playing at a particular/nearby venue. Thus, based on the user's past attendance at an event or based upon profile-based information, songs, artists, events, etc. may be recommended to a user 102/132.

In addition, fuzzy logic may be used in an attempt to determine what to recommend based on the event site specific information. Alternatively, fuzzy logic may be utilized to recommend an event site to a user 102/132 or to an artist/potential event host based on the approximate users 102/132 attributes and the predicted behavior of the user 102/132.

Fuzzy logic is a superset of conventional (Boolean) logic that has been extended to handle the concept of partial truth—truth values between “completely true” and “completely false”. With fuzzy logic, continuous truth values are permitted such that system variables may take a continuous range of truth-value memberships in the interval [0,1], rather than strict binary (True or False) decisions and assignments. For example, if it is cloudy and overcast, the statement “it is raining” could have a True value of 0.8, and a False value of 0.25. Likewise, the statement “The current user 102/132 is a visitor” has the value 0.9 if highly likely, 0.1 if highly unlikely, and 0.5 if the answer is “may be”. In embodiments of the invention, fuzzy logic may be utilized to determine the likely approximate attendance if a person/group were to host an event at a particular venue/location (and may include a recommended season/date/time).

The likelihood of a user 102/132 attending a particular event may be predicted using fuzzy logic. In such an example, the normal location of a user 102/132 (e.g., in a particular suburb or in Los Angeles) may be compared to the user's current location (e.g., downtown or Seattle). Other attributes such as prior attendance at an event (e.g., concerts featuring a particular artist), travel to see such an event, in combination with known facts such as the location of the particular artist's concert the following evening in the vicinity of the user 102/132, may be used to predict with a particularly probability that a user 102/132 will attend the event. Based on such a probability, a particular event site 302 may be recommended to the user 102/132. Alternatively, based on an accumulation of the approximate likelihood of multiple users predicted attendance, a particular location/venue for an event may be suggested/recommended to a potential event host. Thus, an application 306-318 or recommendation engine 312 may rely on fuzzy logic in an attempt to determine when and where to host an event of a particular type or of a particular person/group/performer.

Thereafter, once an event is scheduled at a particular venue, the recommendation engine 312 may be used to drive traffic to the corresponding event site and may interact with such an event site 304 and/or information gathered by the event site 304.

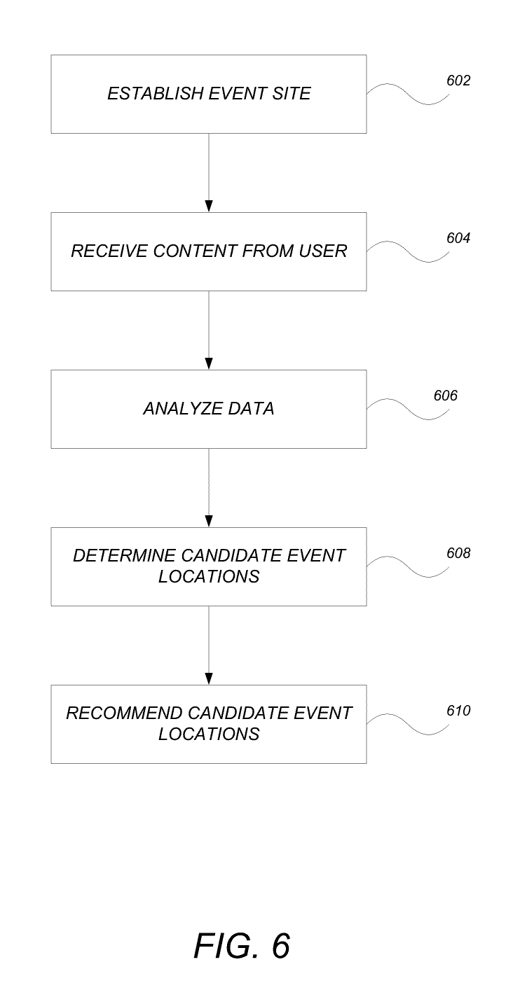

FIG. 6 illustrates the logical flow for providing a concert venue recommendation in accordance with one or more embodiments of the invention.

At step 602, an event site is established. Such an event site corresponds to an event that multiple persons attend and is an electronic repository for content related to the event. Such an event site may be hosted by a social media site and may include installing or utilizing a new instance (e.g., an object oriented instance) of an event application on the event site. To establish the event site, any known information may be stored/associated with the event. For example, the type of event, the artists/participants of the event, the venue, the location of the venue (e.g., latitude and longitude, GPS, street address, etc.) the time and date of the event, links to websites for any of the above, etc. The establishing/publishing/associating of such information with a particular event may all be automated. For example, an event application/controller may webcrawl and when a new upcoming event is discovered (e.g., at an artist's/team's web page, a ticketing company's webpage, etc.), information about the artist/team/venue may be automatically retrieved from a trusted source. The automatic gathering of such information may further provide the ability for an authorized user 102/132 to confirm the information before, during, or after the establishment of the event site. Alternatively, an authorized user 102/132 may be required to establish the event site and content initially stored thereon.

At step 604, content is received, at the event site, from one or more users 102/132 attending the event. The event application may confirm the authenticity of the received content (e.g., via GPS data, receipt of tracking information (e.g., input of user information). The event application may also filter the content to determine if any impermissible content has been uploaded (e.g., obscene, illegal, or nefarious content, content that requires a copyright license, content for which a minimum viewing age may be required, etc.). Such content may further include attendance information of one or more users 102/132 (i.e., information regarding whether the user 102/132 has attended a particular event).

At step 606, the uploaded content is analyzed to extrapolate information about the user 102/132 and predicted user behavior. Such an analysis may also collate predicted user behavior from multiple users 102/132 as well as establish location, artist, song, venue, etc. specific profile information. In this regard, existing profiles for artists, songs, performers, etc. may be supplemented with the collated information (e.g., indicating a fan base in a particular geographic location and/or a popular music genre in a particular geographic location).

At step 608, based on the analyzed content/extrapolated information, candidate event locations are determined. For example, based on prior attendance from certain users 102/132 (e.g., extrapolated from event sites) and a geographic location/focal point for fans of a particular performer/artist, a potential/candidate location for hosting an event may be determined (e.g., a specific venue for a particular artist/performer on a particular date/date range).

At step 610, the candidate event location is recommended/provided to a potential event host (e.g., artist, manager, promotion company, etc.).

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for delivering event-based information, comprising:
(a) establishing an event site, wherein the event site:
(1) corresponds to an event that multiple persons attend; and
(2) comprises an electronic repository for content related to the event;
(b) receiving, content from an attendee of the event;
(c) populating the event site with the content;
(d) populating a graphical user interface of a map with a representation of the event, wherein the map provides navigation capabilities for a user to locate different events on the map;
(e) receiving a selection of the event via the graphical user interface; and
(f) based on the selection, delivering the content from the event site to the user.

2. The method of claim 1, further comprising:
displaying one or more selectable filtering attributes; and
filtering the different events that are displayed on the map based on the one or more selectable filtering attributes.

3. The method of claim 2, wherein the selectable filtering attributes comprise:
artist;
genre; and
geographic location.

4. The method of claim 2, wherein the selectable filtering attributes comprise attributes that are based on information that is uniquely maintained by a social media network.

5. A method for providing an event venue recommendation, comprising:
(a) establishing an event site, wherein the event site:
(1) corresponds to an event that multiple persons attend; and
(2) comprises an electronic repository for content related to the event;
(b) receiving, content from an attendee of the event;
(c) populating the event site with the content;
(d) analyzing the content to extrapolate information about the attendee;
(e) based on the extrapolated information, determining a candidate event location; and
(f) transmitting the candidate event location as an event venue recommendation.

6. The method of claim 5, wherein the analyzing further comprises collating predicted user behavior from multiple attendees.

7. The method of claim 5, wherein the extrapolated information comprises a profile of the attendee.

8. The method of claim 7, further comprising modifying the profile based on the attendees interaction with a social media network.

9. The method of claim 5, wherein the extrapolated information comprises a demographic profile for a particular geographic location.

10. The method of claim 5, wherein the extrapolated information comprises a fan base in a particular geographic area.

11. The method of claim 10, wherein the candidate event location comprises a venue located in the particular geographic area.

12. The method of claim 5, wherein the candidate event location is transmitted to a user based on a profile of the user.

13. A system for delivering event-based information, comprising:
(a) a server computer;
(b) an event application executing on the server computer, wherein the event application:
(1) establishes an event site, wherein the event site:
(i) corresponds to an event that multiple persons attend; and
(ii) comprises an electronic repository for content related to the event;
(2) receives, content from an attendee of the event;
(3) populates the event site with the content;
(4) populates a graphical user interface of a map with a representation of the event, wherein the map provides navigation capabilities for a user to locate different events on the map;
(5) receives a selection of the event via the graphical user interface; and
(6) based on the selection, delivers the content from the event site to the user.

14. The system of claim 13, wherein the event application is further configured to:
display one or more selectable filtering attributes; and
filter the different events that are displayed on the map based on the one or more selectable filtering attributes.

15. The system of claim 14, wherein the selectable filtering attributes comprise:
artist;
genre; and
geographic location.

16. The system of claim 14, wherein the selectable filtering attributes comprise attributes that are based on information that is uniquely maintained by a social media network.

17. A system for providing an event venue recommendation, comprising:
(a) a server computer;
(b) an event application executing on the server computer, wherein the event application:
(1) establishes an event site, wherein the event site:
(i) corresponds to an event that multiple persons attend; and
(ii) comprises an electronic repository for content related to the event;
(2) receives, content from an attendee of the event;
(3) populates the event site with the content;
(4) analyzes the content to extrapolate information about the attendee;
(5) based on the extrapolated information, determines a candidate event location; and
(6) transmits the candidate event location as an event venue recommendation.

18. The system of claim 17, wherein the event application is configured to analyze by collating predicted user behavior from multiple attendees.

19. The system of claim 17, wherein the extrapolated information comprises a profile of the attendee.

20. The system of claim 19, wherein the event application is further configured to modify the profile based on the attendees interaction with a social media network.

21. The system of claim 17, wherein the extrapolated information comprises a demographic profile for a particular geographic location.

22. The system of claim 17, wherein the extrapolated information comprises a fan base in a particular geographic area.

23. The system of claim 22, wherein the candidate event location comprises a venue located in the particular geographic area.

24. The system of claim 17, wherein the candidate event location is transmitted to a user based on a profile of the user.
